(19) United States
(12) Patent Application Publication
(10) Pub. No.: US 2008/0126168 A1
(43) Pub. Date: May 29, 2008

(54) OILFIELD MANAGEMENT SYSTEM

(75) Inventors: Michael Carney, Houston, TX (US); Paul S. Lundy, Katy, TX (US); Randall G. McKee, Katy, TX (US); Phalyn Pao, Katy, TX (US); David J. Rossi, Katy, TX (US); Peter A. Schipperijn, Houston, TX (US); David N. Shipley, Vallejo, CA (US); Ian H. Traboulay, Sugar Land, TX (US)

Correspondence Address: OSHA . LIANG L.L.P. / SLB, 1221 MCKINNEY STREET, SUITE 2800, HOUSTON, TX, 77010, US

(73) Assignee: SCHLUMBERGER TECHNOLOGY CORPORATION, Houston, TX (US)

(21) Appl. No.: 11/940,222

(22) Filed: Nov. 14, 2007

Related U.S. Application Data
(60) Provisional application No. 60/859,398, filed on Nov. 15, 2006.

(51) Int. Cl. G05B 19/418

(52) U.S. Cl. 705/8

(57) ABSTRACT

Systems and methods of managing a workflow of an oilfield activity are provided. A problem in the oilfield activity is identified, where the oilfield activity includes a number of tasks necessary to complete a project of a number of projects in the workflow, and where the number of tasks are arranged within a number of workflow states associated with the oilfield activity. A sequence for the number of tasks is selectively updated based on an analysis of the oilfield activity performed by a user. The project is analyzed by examining a progress of the project within one of the number of workflow states to obtain a decision, where the project is associated with the problem. The problem is resolved in the oilfield activity based on the decision.

### CROSS-REFERENCE TO RELATED APPLICATIONS

This application claims priority, pursuant to 35 U.S.C. § 119(e), to U.S. Patent Application Ser. No. 60/859,398, entitled “Oilfield Management System,” filed on Nov. 15, 2006, which is herein incorporated by reference in its entirety.

### BACKGROUND

Oilfield activities involve various sub-activities used to locate and gather valuable hydrocarbons. Various tools, such as seismic tools, are often used to locate the hydrocarbons. One or more wellsites may be positioned along an oilfield to locate and gather the hydrocarbons from subterranean reservoirs of an oilfield The wellsites are provided with tools capable of advancing into the ground and removing hydrocarbons from the subterranean reservoirs. Production facilities are positioned at surface locations to collect the hydrocarbons from the wellsite(s). Fluid is drawn from the subterranean reservoir(s) and passes to the production facilities via transport mechanisms, such as tubing. Various equipment is positioned about the oilfield to monitor and manipulate the flow of hydrocarbons from the reservoir(s).

During oilfield activities, it is often desirable to monitor various oilfield parameters, such as fluid flow rates, composition, etc. Sensors may be positioned about the oilfield to collect data relating to the wellsite and the processing facility, among others. For examples, sensors in the wellbore may monitor fluid composition, sensors located along the flow path may monitor flow rates and sensors at the processing facility may monitor fluids collected. The monitored data is often used to make real-time decisions at the oilfield. Data collected by these sensors may be further analyzed and processed.

The processed data may be used to determine conditions at the wellsite(s) and/or other portions of the oilfield, and make decisions concerning these activities. Operating parameters, such as wellsite setup, drilling trajectories, flow rates, wellbore pressures, production rates and other parameters, may be adjusted based on the received information. In some cases, known patterns of behavior of various oilfield configurations, geological factors, operating conditions or other parameters may be collected over time to predict future oilfield activities.

Oilfield data is often used to monitor and/or perform various oilfield activities. There are numerous factors that may be considered in operating an oilfield. Thus, the analysis of large quantities of a wide variety of data is often complex. Over the years, oilfield applications have been developed to assist in processing data. For example, simulators, or other scientific applications, have been developed to take large amounts of oilfield data and to model various oilfield activities. Typically, there are different types of simulators for different purposes. Examples of these simulators are described in U.S. Pat. No. 5,992,519, WO2004049216 and U.S. Pat. No. 6,980,940.

Numerous oilfield activities, such as drilling, evaluating, completing, monitoring, producing, simulating, reporting, etc., may be performed. Typically, each oilfield activity is performed and controlled separately using separate oilfield applications that are each written for a single purpose. Thus, many such activities are often performed using separate oilfield applications. In some cases, it may be necessary to develop special applications, or modify existing applications to provide the necessary functionality.

In some cases, it is desirable to automate certain activities and/or certain steps of such activities. Workflows have been developed to perform the desired activities in a desired format. A decision support workflow is a sequential series of steps, with each step requiring an action before taking the next step. The final step includes a decision based upon the outcomes of all the previous steps made in the workflow. A workflow can be any defined activity or task, such as delivering parcels to customers, completing an oilfield drilling activity, or testing the reliability of an electrical component.

Workflows include at least two types. A first type is a linear or sequential type. A second type is a complex type. An example of a linear workflow is an approval process where a series of sequential steps are being followed for an approval to occur. Several people in a hierarchy make successive authorizations in a specific sequence in order for the approval to be obtained.

In contrast, a complex workflow provides several paths that can be taken through the process. Decision points may include alternatives such as yes or no, left or right, up or down, etc. An alternative may lead to a loop. A person or group following a workflow passes through the maze of steps. Once all the criteria are met, the user exits the process.

A subtype of the complex workflow is an unstructured complex workflow. The path through an unstructured complex workflow is undefined and depends upon varying input parameters and the specific problem to solve. In other words, the path of an unstructured complex workflow may vary depending on the decision points as well as the attributes of the specific problem to be solved. The approach to this workflow also varies with the experience of the user community. More specifically, the logic defining the decision points in the paths of the workflow may evolve based on the experience of the user community.

There are tools to manage conventional business process management workflows. Examples include Microsoft® Windows Server System™ BizTalk Server 2006 (as described in Understanding BizTalk Server 2006 published by Microsoft Corporation in October 2005), K2.net® 2003 enterprise workflow solutions, and One Virtual Source™ (a product for production surveillance and optimization) from Merrick Systems.

Despite such advances in workflow technology, there remains a need to develop techniques for selectively performing oilfield activities according to a desired format. It is desirable that such new techniques be capable of one or more of the following, among others: allow a flexible user interface and methodology to manage many types of decision support workflows from simple to unstructured complex; manage multiple workflows; view the status of projects within a workflow; manage multiple, potentially different users for each project and workflow; keep track of the data and actions taken, and records the current status, history; progress through the workflow for each project; and manage a project through multiple workflows.

### SUMMARY

In general, in one aspect, the present invention relates to a method of managing an oilfield activity for an oilfield. The oilfield has at least one processing facility and at least one wellsite operatively connected thereto, each at least one wellsite having a wellbore penetrating a subterranean formation for extracting fluid from an underground reservoir therein. The method includes identifying a problem in the oilfield activity, where the oilfield activity comprises a number of tasks necessary to complete a project of a number of projects in a workflow, and where the number of tasks are arranged within a number of workflow states associated with the oilfield activity. The method further includes selectively updating a sequence for the number of tasks based on an analysis of the oilfield activity performed by a user, analyzing the project by examining a progress of the project within one of the number of workflow states to obtain a decision, where the project is associated with the problem, and resolving the problem in the oilfield activity based on the decision.

In general, in one aspect, the present invention relates to a method of managing an oilfield activity for an oilfield. The oilfield has at least one processing facility and at least one wellsite operatively connected thereto, each at least one wellsite having a wellbore penetrating a subterranean formation for extracting fluid from an underground reservoir therein. The method includes identifying a problem in the oilfield activity, where the oilfield activity comprises a number of tasks necessary to complete a project of a number of projects in a workflow, and where the number of tasks are arranged within a number of workflow states associated with the oilfield activity. The method further includes determining whether a user is an advanced user, where after the determination, the user updates the plurality of tasks. The method further includes analyzing the project by examining a progress of the project within one of the number of workflow states to obtain a decision, where the project is associated with the problem, and resolving the problem in the oilfield activity based on the decision.

In general, in one aspect, the present invention relates to a method of managing an oilfield activity for an oilfield. The oilfield has at least one processing facility and at least one wellsite operatively connected thereto, each at least one wellsite having a wellbore penetrating a subterranean formation for extracting fluid from an underground reservoir therein. The method includes identifying a problem in the oilfield activity, where the oilfield activity comprises a number of tasks necessary to complete a project of a number of projects in a workflow, and where the number of tasks are arranged within a number of workflow states associated with the oilfield activity. The method further includes analyzing the project by examining a progress of the project within one of the number of workflow states to obtain a decision, where the project is associated with the problem, resolving the problem in the oilfield activity based on the decision, and recording data and actions taken to resolve the problem, where the data and the actions are used to analyze the effectiveness of the resolving.

In general, in one aspect, the present invention relates to a user interface for managing an activity. The user interface includes a number of tasks necessary to complete a project of a number of projects in a workflow, where the number of tasks are arranged within a number of workflow states associated with the activity. The user interface further includes a number of user profiles associated with at least one of the number of projects, where the project is associated with the problem with the activity and analyzed by examining a progress of the project within one of the number of workflow states to obtain a decision, where the problem in the activity is resolved based on the decision.

In general, in one aspect, the present invention relates to a computer system for managing an oilfield activity for an oilfield. The oilfield has at least one processing facility and at least one wellsite operatively connected thereto, each at least one wellsite having a wellbore penetrating a subterranean formation for extracting fluid from an underground reservoir therein. The computer system includes a processor, memory, and software instructions stored in memory to execute on the processor to identify a problem in the oilfield activity, where the oilfield activity comprises a number of tasks necessary to complete a project of a number of projects in a workflow, and where the number of tasks are arranged within a number of workflow states associated with the oilfield activity. The software instructions further execute to determine whether a user is an advanced user, where after the determination, the user updates the plurality of tasks. The software instructions further execute to analyze the project by examining a progress of the project within one of the number of workflow states to obtain a decision, where the project is associated with the problem, and to resolve the problem in the oilfield activity based on the decision.

Other aspects of the invention will be apparent from the following description and the appended claims.

### BRIEF DESCRIPTION OF DRAWINGS

FIG. 1 shows an exemplary oilfield activity having a plurality of wellbores linked to an operations control center.

FIG. 2 shows two wellbores in communication with the operations control center of FIG. 1.

FIG. 3 shows a detailed view of the operations control center of FIG. 2.

FIGS. 4-5 shows a state diagram for an exemplary workflow.

FIG. 6 shows an exemplary user interface for a workflow.

FIGS. 7-12 show exemplary screenshots of a workflow interface of an oilfield management activity.

FIGS. 13-15 show exemplary screenshots of a watch list feature of a workflow interface for an oilfield management activity.

FIGS. 16-17 show exemplary screenshots of an administration tool feature of a workflow interface for an oilfield management activity.

FIG. 18 show exemplary screenshots of a workflow interface of an automobile sales activity.

### DETAILED DESCRIPTION

In general, aspects of the invention relate to managing a workflow of an activity, such as an oilfield activity, to resolve a problem associated with the oilfield activity in accordance with one embodiment of the invention. More specifically, embodiments of the invention identify a problem, analyze a project related to the activity which appears to be the source of the problem and examine progress of the project within various states of a workflow to obtain a decision used, in part, to resolve the problem in accordance with one embodiment of the invention.

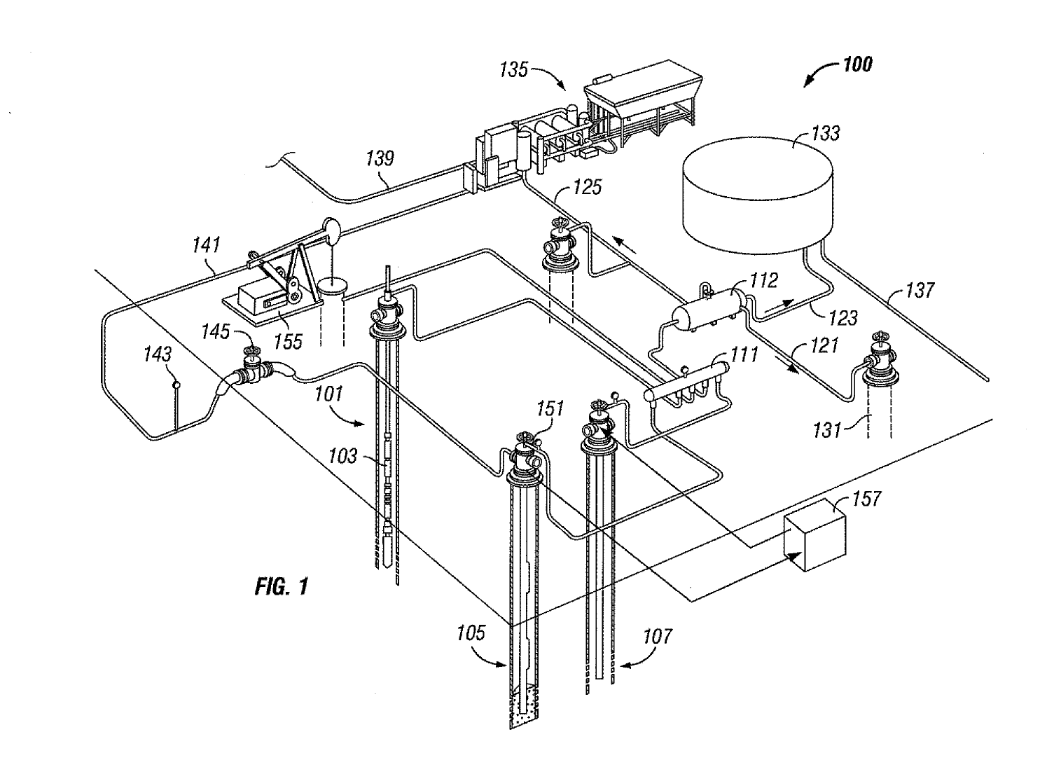

Further, aspects of the invention may be used to analyze workflows in any number of industries. One such industry is the oil and gas industry. FIGS. 1-3 depict an overview of an example containing various aspects of the oil and gas industry. Briefly, an oilfield activity may take many forms including operations performed before any drilling occurs, such as, for example, exploration, analysis, etc. In addition, an oilfield activity may include activities occurring after drilling, for example, well work over and intervention, as well as storage, transport and refining of hydrocarbons. Furthermore, an oilfield activity may also include activities performed during drilling.

Turning to FIG. 1, an oilfield activity (100) is depicted including machinery used to extract hydrocarbons, such as oil and gas, from down-hole formations. An operations control center (157) may assist in collecting data and making decisions to enhance operations in the oilfield. Data may include, for example, measurements of bottom hole pressure and tubing head pressure.

As shown in FIG. 1, the oilfield activity (100) include a number of wells. Specifically, the oilfield activity (100) include first producing well (101), which uses an electric submersible pump (103) to produce a hydrocarbon (e.g., oil, gas, etc.); a second well (105), which relies on a gas lift to produce a hydrocarbon; and a third well (107), which produces a hydrocarbon on the basis of natural flow. First producing well (101), second well (105), and third well (107) deliver production fluids (e.g., hydrocarbon produced from their respective wells) to a production manifold (111). The production manifold collects multiple streams and outputs the streams to a gas and oil separator (112).

Upon receipt of the production fluids by the gas and oil separator (112), the gas and oil separator (112) separates various components from the fluids, such as produced water (121), produced oil (123), and produced gas (125), respectively to water disposal well (131), oil storage (133), and a compressor station (135). Oil storage (133) may transfer oil via an oil export pipeline (137). Similarly, the compressor station (135) may use gas export pipeline (139) to transfer gas. Finally, the compressor station (135) may process gas as an injection gas (141).

In order to adjust pressure on the injection gas, a meter and control system (143) may cooperate with an injection-gas manifold (145). The operation of the meter and control system (143) may regulate pressure of the injection gas as the injection gas is delivered to a wellhead tubing and casing (151). In addition to the injection gas, extracting efforts may rely upon a rod pump (155) to drive a downhole pump assembly via a reciprocating motion. In such cases, the rod pump (155) propels hydrocarbons to the production manifold (111).

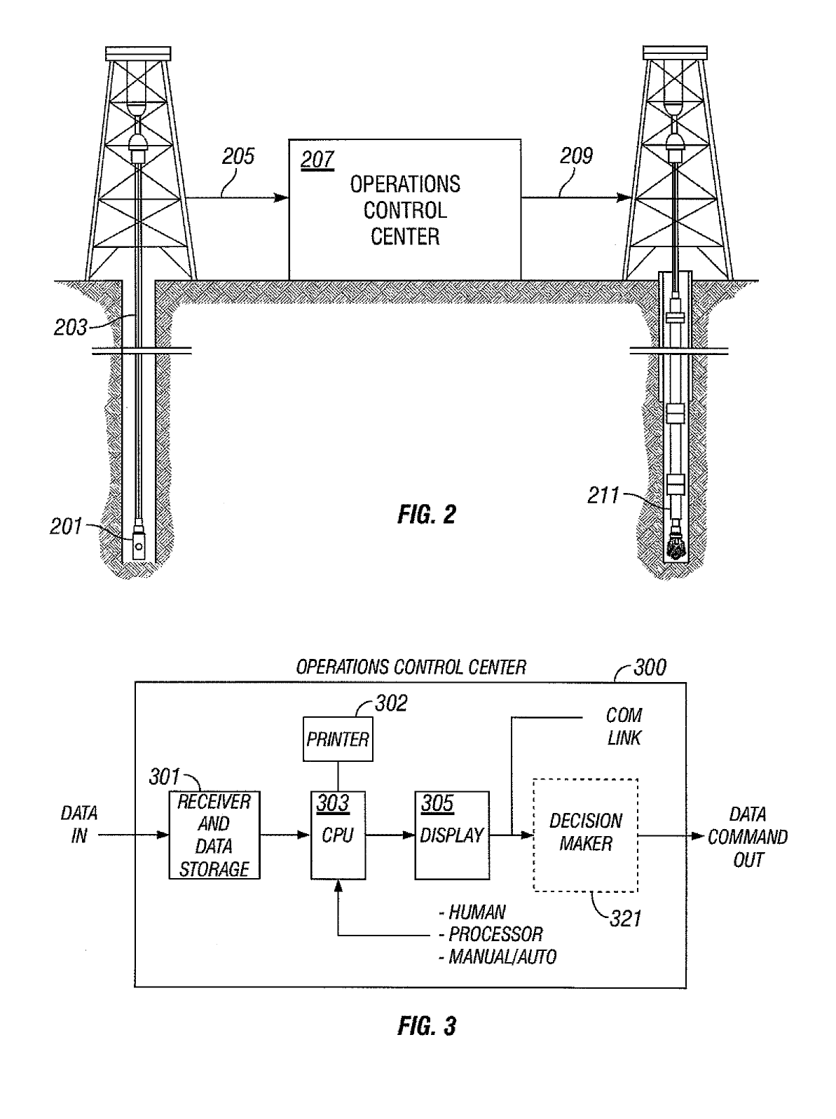

In one embodiment of the invention, the operations control center (157) may receive data from sensors corresponding to the second well (105). Examples of sensors are depicted and described in further detail with respect to FIG. 2. The sensors may include, for example, a pressure sensor that measures fluid pressures at the wellhead. The operations control center (157) may also operate and/or control equipment in the third well (107).

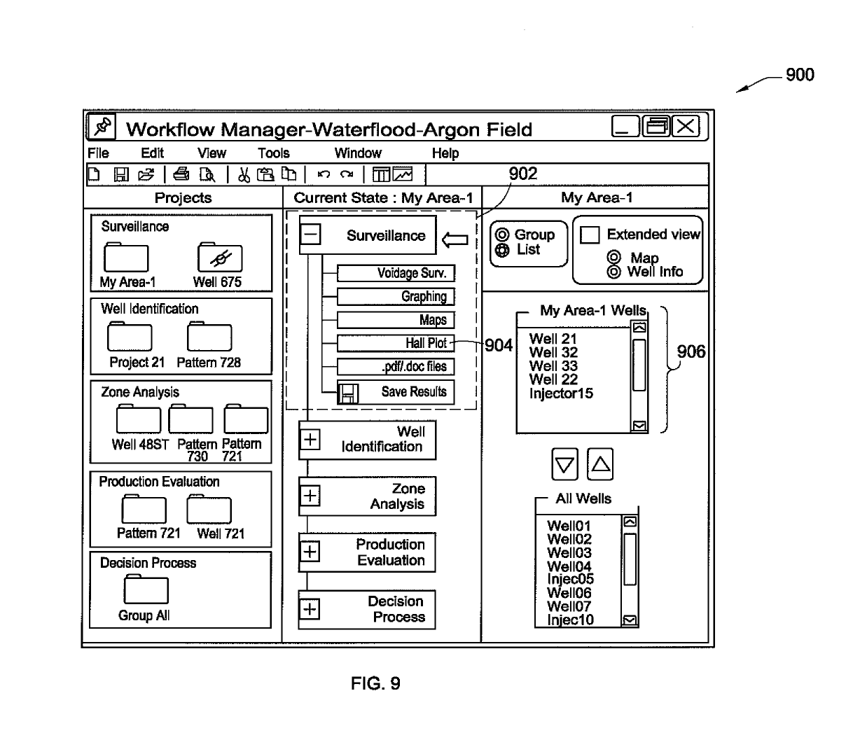

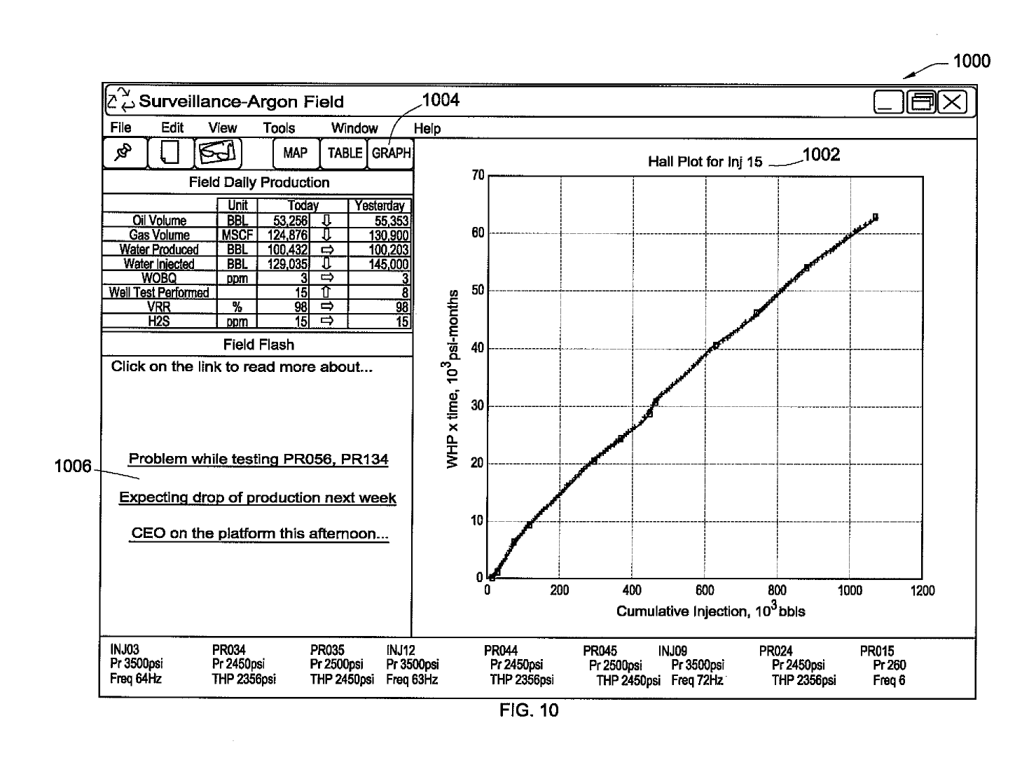

An operations control center may use a data processing system including various components, such as those depicted in FIG. 3. These components may be, for example, a communication unit (i.e., receiver and data storage (301)), a central processing unit (i.e., CPU (303)), and a memory (i.e., receiver and data storage (301)) all of which may be operatively connected via a bus. The memory is preferably configured to store one or more sets of instructions. Further, the CPU (303) (e.g., a microprocessor, a human) is preferably configured to execute one or more of the sets of instructions to control, for example, the operation of the third well (107). In addition, the CPU (303) may also calculate averages or otherwise combine inputs, as will be described in relation to FIGS. 9 and 10. Finally, the communication unit preferably operates as an interface between the operations control center (157) and the other oilfield operations components. As such, the communications interface may be configured to receive data from the oilfield operations components and to send commands and/or data to the oilfield operations components.

FIG. 2 shows a portion of the wellbore operation, such as the wellbore operation of FIG. 1, in greater detail. This diagram depicts the cooperation of the operations control center (207) with at least two wells. As discussed above, a purpose of the operations control center (207) is to collect data and control a drilling operation. The down-hole sensors (201) and well-head sensors (203) provide data (i.e., data collected and/or otherwise obtained from the down-hole sensors (201) and/or the well-head sensors (203)). Upon receipt of the information, a first communication link (205) transfers the aforementioned data to the operations control center (207).

The operations control center (207) stores and, in some cases, optionally processes and/or analyzes the data. In some cases, the operations control center (207) may also generate and transmit control signals via the second communication link (209) to a down-hole apparatus (211). For example, the operations control center (207) may automatically generate control signals using data obtained via communications link (205). In another example, the operations control center (207) may provide information to an operator that may consider the information, and then send control signals as desired. In addition, in some embodiments of the invention, the operations control center (207) may also provide feedback to down-hole sensors (201) and/or well-head sensors (203) using data obtained via communications link (205).

FIG. 3 shows an operations control center (300) that may be used with the oilfield operations of FIGS. 1 and 2. A receiver and data storage (301) corresponds to a device configured to receive and store data, for example, from a sensor (i.e., (201, 203) of FIG. 2) or other components internal and/or external to the operations control center (300). Receiver and data storage (301) may be implemented, for example, using a magnetic storage device, an optical storage device, a NAND flash storage device, any combination thereof, etc.

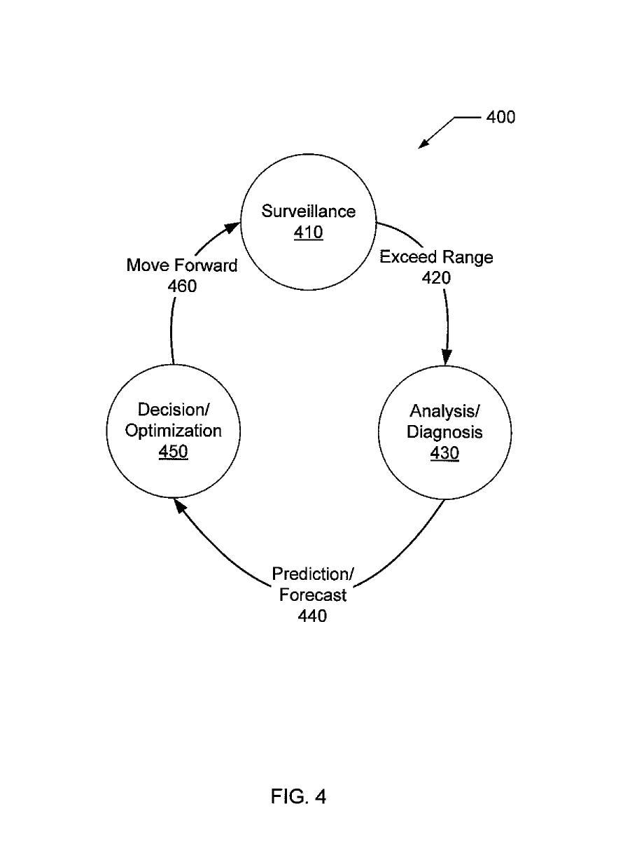

A CPU (303) (e.g., a microprocessor) is configured to process data (e.g., data stored in the receiver and data storage (301)), to store processed data and/or generate commands to operate various oilfield components shown in FIGS. 1 and 2. In addition, the CPU (303) may operate output devices such as a printer (302), for example, to print out a questionnaire for collecting opinions. The CPU (303) may also operate a display device (305) (e.g., a monitor, etc). For example, the display (305) may show workflows such as described in FIG. 4. A decision-maker (321) may optionally contribute to selecting a work element for enhancing. For example, the decision-maker (321) may operate a keyboard or mouse (not shown) to register estimates (discussed below). The CPU (303) may also store such estimates or rated elements (discussed below) to the receiver and data storage (301).

FIG. 4 shows a state diagram for an exemplary workflow in accordance with an exemplary embodiment of the invention.

When a problem is identified during surveillance of an activity (e.g., an oil or gas field production and other operating parameters), the user opens/starts a project within a workflow manager to track the problem analysis and resolution. The workflow manager is used to keep track of the various actions and states of the project to resolve the particular problem. Many projects (or problems within project) can be tracked simultaneously with the workflow manager. A project, as used herein, may be an asset (e.g., a well, a pump, etc.) of the activity, a pattern of assets (i.e., a grouping of assets related by location and/or functionality), a single project, and/or multiple projects.

The workflow manager can keep track of workflow status for linear workflows, parallel workflows or any combination of serial and parallel tasks including nested workflows and unstructured complex workflows. The workflow manager may provide access to one or more users, who may be geographically dispersed.

The Workflow Manager may automatically keep track of all actions taken by the user(s). Additionally, the user(s) may have the ability to add comments as well as the results of their studies and investigations. In this example, one benefit of the Workflow Manager is that information associated with each project may be archived. The archived projects may serve as a repository of a body of knowledge containing all the projects, the information about how they were solved, and all the results. This body of knowledge provides a rich source of data, information, and knowledge that may be mined at some future date. User(s) would be able to search for problems similar to the problems currently identified to understand how the problem has occurred and has been solved.

The basic process of making a decision from available data and information typically involves the main workflow steps shown in the state diagram (400) of FIG. 4.
Surveillance state (410): Observing the trends of an activity against a pre-determined forecast or set of predetermined values. This may be an automated process requiring little user intervention until alerts are displayed. An alert is an indication that operating parameters are out of an expected range, or that a trend is developing which could lead to parameters being outside of an expected range (420). Some user interaction may be warranted during the surveillance step. Pre-analysis tasks may be performed during this state.
Analysis and Diagnosis states (430): In this state, a user may believe there is a problem developing. In addition, the user may perform a routine or scheduled review of the process or program of interest. Consequently, the user gathers relevant information to better understand the problem. Analysis is performed to determine whether the observations are consistent with one or more potential problems. The analysis supports a diagnosis of the problem and also provides predictions that characterize possible forecasts under various operating conditions. Analysis and diagnosis involve a set of tasks executed in an order determined by the user. Alternatively, the order of tasks may be pre-determined and prescribed as a policy or standard procedure. These predictions and/or forecasts (440) are provided to assist with a decision or optimization, as appropriate.
Decision/optimization state (450): In the last main workflow state, based on the outcomes of all the above states and tasks, the user decides the best way to move forward (460), which may involve taking an action.

At the end of the decision process, and after the remedial action has been taken (as defined by the decision), the user may return to a surveillance state to observe the outcome of the decision. Alternatively, a user may return to a surveillance state at any time to view updated information. Of course, while discussed as involving user involvement, one skilled in the art will appreciate that these steps may be performed without user intervention in an automated fashion.

Depending on the workflow, each state may contain several tasks within that state. These tasks in turn may include several sub-tasks depending on the complexity of the decision workflow process. The user may repeat one or more sub-tasks until the user has completed the task and is ready to move on to the next task or move to the next state. The user may skip a task or sub-task, or return to one previously completed to re-evaluate his/her thoughts. These types of complexities may need to be managed without reference to a diagram of the actual workflow.

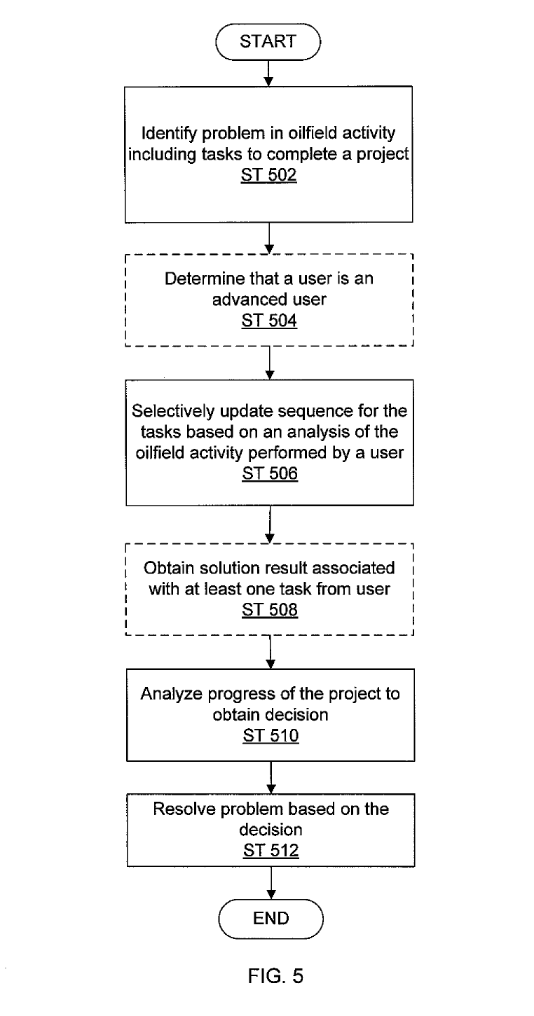

FIG. 5 shows a flow chart depicting a method of managing an oilfield activity. The method may be performed at, for example, the workflow manager as described in FIG. 4. The method may involve identifying a problem in an oilfield activity including tasks to complete project (ST 502), determining that a user is an advanced user (ST 504), selectively updating a sequence for the tasks based on an analysis of the oilfield activity performed by the user (ST 506), obtaining a solution result associated with at least one task from the user (ST 508), analyzing a progress of the project to obtain a decision (ST 510), and resolving the problem based on the decision (ST 512).

The problem in an oilfield activity may be identified (ST 502). For example, a user may identify a problem during surveillance of an oilfield activity. In another example, a user may identify a problem during analysis of the oilfield activity. More specifically, a user may identify a problem based on log data collected during the oilfield activity. Once identified, the user may enter store information associated with the problem using the workflow manager. The problem may include a number of tasks for completing a project. In this case, the user may use the workflow manager to store information related to the tasks. The oilfield activity may include a number of tasks. Further, each task may be associated with a workflow state, as described above in FIG. 4.

Optionally, a determination is made that the user is an advanced user (ST 504). The workflow manager may be configured to store information associated with users. More specifically, the workflow manager may classify users based on a variety of attributes associated with the users. Examples of attributes associated with the users include, but are not limited to: security clearance, business organization, expertise, or company department. For example, the workflow manager may store information related to a user's familiarity with the project. If the user is highly familiar with the project, the user may be classified as an advanced user. An advanced user may be able access additional features of the workflow manager. Alternatively, if the user is unfamiliar with the project, the user may be classified as a novice user. In this case, the novice user may have limited privileges in the workflow manager. Further, the novice user may be required to follow a specific sequence for tasks when using the workflow manager.

A sequence for the tasks may be selectively updated based on analysis of the oilfield activity performed by the user (ST 506). In one example, the user may skip at least one task using the workflow manager. In another example, the user may change the sequence of at least one task using the workflow manager. In another example, the user may add a new task to the sequence of tasks using the workflow manager. In these examples, the user may update the sequence based on the user's analysis of the oilfield activity. For example, the user may decide a task is unnecessary because the task is redundant in a particular oilfield activity and remove it from the sequence.

Optionally, a solution result associated with at least one task may be obtained from the user (ST 508). The user may take action based on a task to resolve the problem. In this case, the user may use the workflow manager to store information related to the user's action. More specifically, the user may use the workflow manager to store a solution result associated with at least one task. The solution result may specify actions taking during the completion of a task. The solution results may be used to create or update tasks for simplifying the oilfield activity. For example, a solution result may be used to selectively update a sequence for the tasks as described in ST 506.

Next, a progress of the project may be analyzed to obtain a decision (ST 510). For example, the user may make the decision based on a solution result from at least one task. Once the decision is made, the problem may be resolved based on the decision (ST 512). Further, the user may observe the resolution of the problem to gather additional information associated with the project.

Other users may observe the progress of the project during the oilfield activity. Further, other users may provide input or accomplish tasks using the workflow manager. In this case, multiple users may simultaneously accomplish tasks during the oilfield activity. Then, the decision may be made based on the input of multiple users.

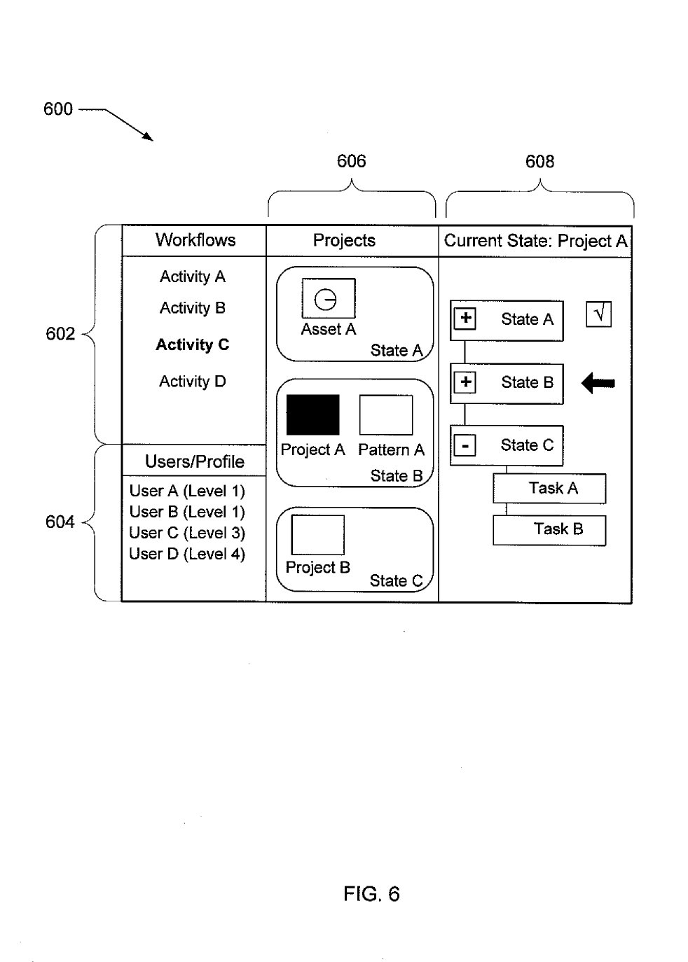

FIG. 6 shows an exemplary user interface as shown in the screen shot (600) for a workflow in accordance with an exemplary embodiment of the invention.

The strength of the workflow manager design may simplify and provide visibility to the movement between states, tasks, and sub-tasks of a workflow. This presentation of the workflow manager may fit on a single display or part thereof, to be maximized, minimized, expanded, etc. In addition, the workflow manager may support multiple displays to provide multiple simultaneous views.

The workflow manager may record moves between states, tasks, and sub-tasks. In addition, the workflow manager records who made the moves and when. The workflow manager allows other (invited) users to view the progress of a project within a workflow, and view the results (if any) from any state, task or sub-task.

The user interface may display a number of workflows (602). Each workflow may specify a different oilfield activity. Examples of oilfield activities include, but are not limited to: water flooding, sanding, gas lifting, well testing, coning, and production management. The user interface may also display a number of user profiles (604). Each user profile may correspond to a different user of the workflow manager. Further, the user interface may also specify a user level for each of the user profiles. A user level may specify functionality available to a user profile of the user level. For example, an advanced user level may be provided functionality to update the sequence of tasks. In another example, a novice user level may be required to use a predefined sequence for tasks.

Each workflow may be associated with a number of workflow state(s) (606). Each workflow state (606) may be associated with a project. A project may be an asset (e.g., a well, a pump, etc.) of the activity, a group of assets, a single project, and/or multiple projects. If a project is selected in the user interface, the current state (608) of the project may be displayed. The current state (608) of the project may display the current progress of the project within the selected workflow. More specifically, the current state may display a number of tasks for each workflow state (606). Further, each task may be designated as complete or incomplete. The user may selectively update the sequence of the tasks using the current state (608) of the project. For example, the user may select a specific task in the current state (608) to complete.

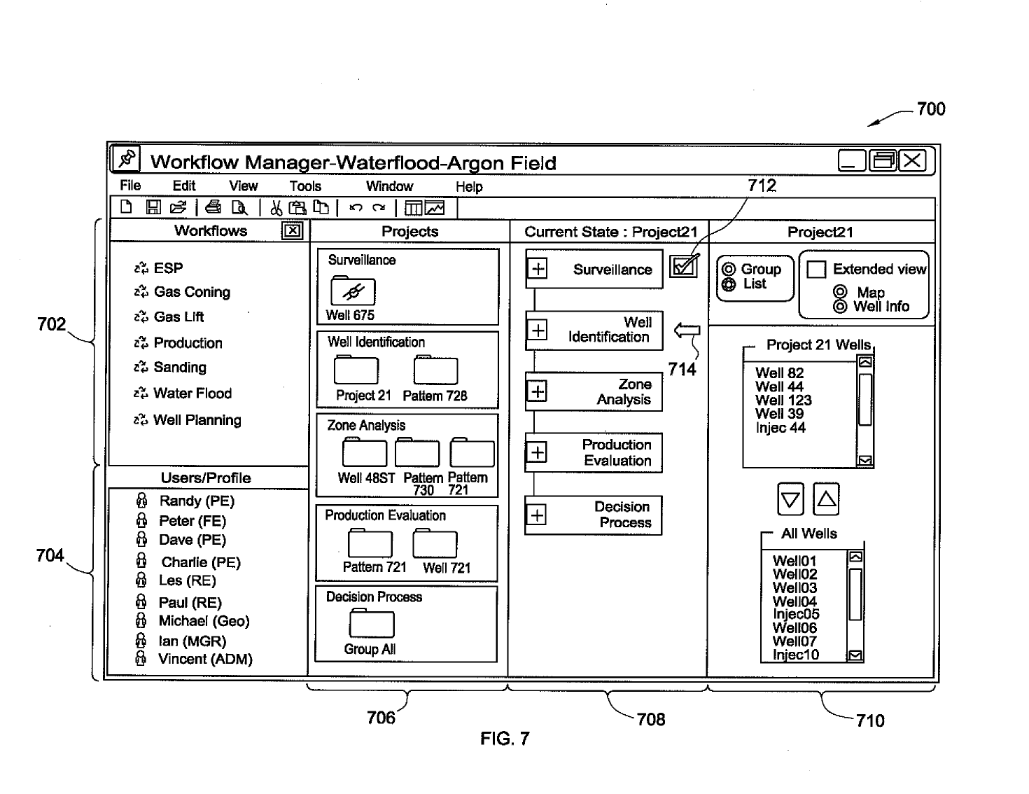

FIGS. 7-18 depict specific examples of an interface for decision support workflow management that may be used to analyze workflows of various industries, such as the oil and gas industry.

In one aspect of the invention, a workflow manager may provide many varieties of decision support workflows both within and external to the oil and gas industry. An example of a support workflow is an oilfield water-flooding program. More specifically, aspects of the invention relate to applying an unstructured complex workflow to the activity of waterflooding in the oil and gas field. Waterflooding involves injecting water into subsurface oil reservoirs to force oil to move toward nearby oil production wells. The waterflood workflow includes activities such as data measurement and observation, problem diagnosis, and analysis. Unlike many common workflows, which flow sequentially from beginning to end, the waterflood workflow may involve iterative steps and/or jumps. The waterflood workflow may follow different paths depending on the task being solved.

FIG. 7 shows one example of what a screen shot (700) of the Workflow Manager may appear to a user. The example described herein is a waterflood workflow. In an oilfield activity, all the waterflood activities (such as managing injected water volumes, monitoring reservoir and wellbore pressures, and monitoring produced fluid volumes) are normally grouped together and called the waterflood program. As problems such as decreasing reservoir pressure are recognized within the waterflood program (e.g., by using the surveillance system described above), the workflow manager allows users to create a waterflood project to track and record the resolution of the problems as shown in column two (second column from the left) of FIG. 7. A waterflood workflow may then be executed for each waterflood project (or problem associated with the project). The waterflood workflow of a specific problem is shown in column 3 (708) of FIG. 7 for the selected problem found in project 21.

The two middle columns initially look similar, but closer investigation shows that they show the status of all projects in the waterflood program (706), and the status of the workflow for the specific project selected (708). The status of the workflow shows the different states of the workflow; in sequence from beginning to end (these can and probably will be different for different workflows). For example, in the Waterflood Workflow, the states are:
Surveillance
Well identification
Zone analysis
Production evaluation
Decision process

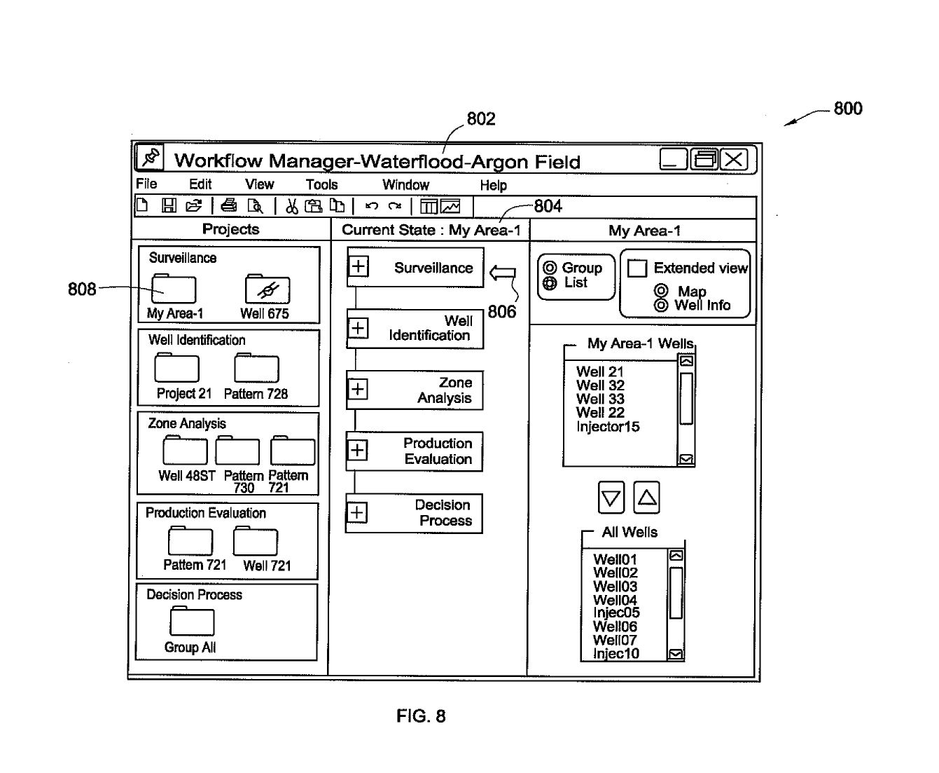

Each state has many tasks and possibly sub-tasks (see, FIG. 8 below).

In FIG. 7 the column titled “Projects” (706) shows all waterflood projects (with problems being resolved). “Project 21” is the project currently being worked on. Project 21 is in the Well Identification state. Under the column titled “Current State: Project 21” (708) an arrow (714) pointing to the Well Identification state. A checkmark (712) in the box adjacent to Surveillance confirms that this state has been exited. The workflow manager generally generates the checkmark but it can be over-ridden by the user. Other forms of indicating the status of a state, task and sub-task are possible.

The column on the far right (710) displays the user specific information on the project. For example, he/she has chosen to view a list of all of the asset wells. The user may select specific wells to form a list of wells that form the project. As the user moves through the workflow he/she may remove, or add wells to the project as he/she performs diagnosis.

In another workflow, wells may not be integral to the workflow. For example in a workflow managing facilities, pumps, compressors, valves, etc. may be the entities that are managed within the context of the workflow.

At bottom left of the screen (704) is an area showing the users included in the current active waterflood project being worked on. In parentheses is an acronym showing the user profile, for example, RE=Reservoir Engineer. These users are invited by the person who creates a project.

The workflow manager is not limited to only waterflood workflows. A list of additional workflows the user may choose to work on are listed in the upper left of the screen (702). In that area of the screen “Waterflood” may be highlighted. The highlighting may indicate that the highlighted text is a title or otherwise representing the current workflow chosen to work on. At the very top of the screen the word or title “Waterflood” is also shown, along with the field or asset the current workflow is applied to.

As a further guide to how the tool is designed to work, the next few figures show how the user may create a project and move it through some of its states and tasks.

FIG. 8 shows a screen shot (800) of how the Workflow Manager may look after a new project—“My-Area 1,” has been created. The users have been invited, but the column that shows the workflows and users has been hidden to save screen space. Further, the current workflow is displayed in the title bar (802) of the window. The project is in the Surveillance state, highlighted by both the selected (darkened) project folder (808) in the “Projects” column and the arrow (806) in the “Current State” column (804). The wells have already been chosen for the Project.

FIG. 9 shows a screen shot (900) of the result of expanding the Surveillance state (in the “Current State” column) by clicking on the cross in the task box which reveals all of the tasks (902). The task “Hall Plot” (904) allows the user to view a Hall Plot in the surveillance state. By clicking this button the user sees a screen similar to FIG. 10. The wells the user may view (906) may be limited to the wells chosen for the project. In particular, as the wells for a Hall Plot may be injectors, the only well that could be displayed would be Injector 15 (FIG. 8, column 3, “My-Area 1 wells” box).

The flexibility of this workflow manager allows the user to pick any box or step within the task. This has been specifically designed this way to enable more advanced users to go to the specific task desired without being required to step through each task. At the same time, for users less familiar with the process, this layout acts as a guide and reminder of all the possible steps through the workflow. Finally, the last box in the surveillance state (FIG. 9) is available to the users to record results of each state.

FIG. 10 shows a screen shot (1000) of a Hall Plot as created in accordance with the exemplary scenario from FIG. 9. The selected injection well for the Hall Plot is identified (1002) in the display. Further, the type of output is designated as a graph (1004). The display may also include news (1006) related to the selected injection well.

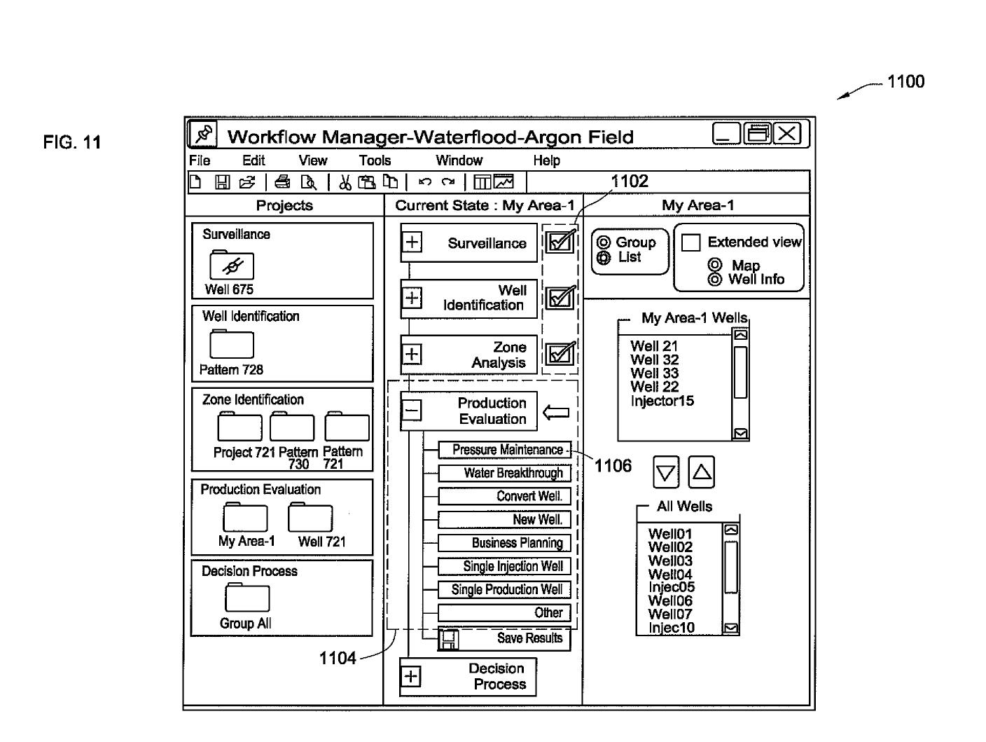

The user moves between states and tasks by dragging and dropping the currently active project file from one state or task in the “Projects” column to another. This method allows the user the ability to move back up to a state or task that needs re-evaluation, or to skip a state/task altogether. By the time the user reaches the Production Evaluation state, the Workflow Manager displays a screen similar to FIG. 11.

FIG. 11 shows a screen shot (1100) of a detailed view of the product evaluation task. The tasks listed in the production evaluation state (1104) are displayed as problem types. A problem type permits an engineer to determine the type of analysis he/she would have to perform. These problem types may be pre-determined by the user at the time the workflow manager is installed or reconfigured (see below). Depending on the problem type, a set of pre-determined analytical applications may be made available to the user. The applications may be determined by the user during installation/reconfiguration, where they would be assigned to the problem type.

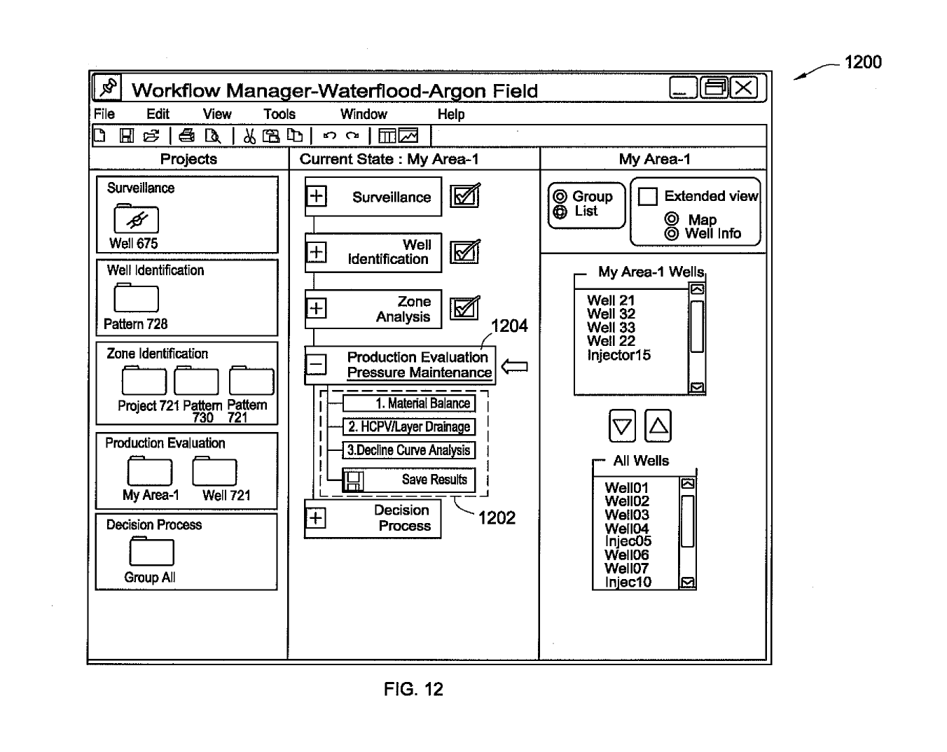

By clicking on a problem type button, for example, pressure maintenance (1106), the user would see a screen that would look like FIG. 12.

FIG. 12 shows a screen shot (1200) of a detailed view of a problem type selected by the user (1204). The workflow manager displays the applications (1202) available to the user for the problem type chosen. The numerical order is a suggestion, entered during installation. An expert user may able to choose which applications to use in any order. A more novice user, however, may follow the sequence displayed.

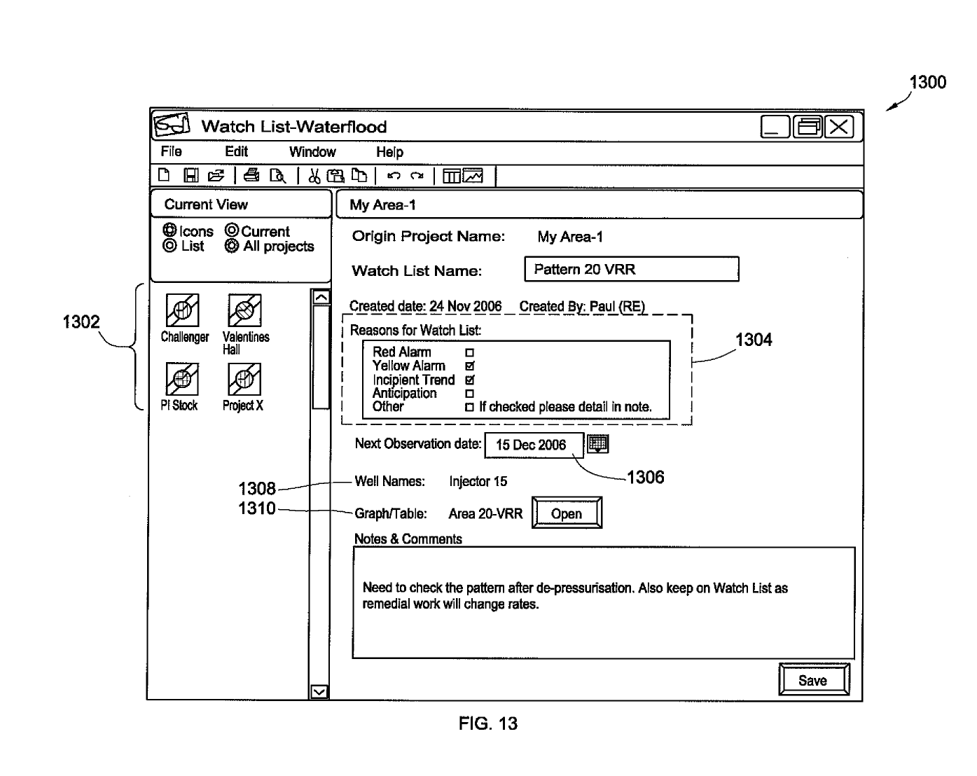

FIG. 13 shows a screen shot (1300) of the Watch List layout as it would appear to the user. Using the watch list, users may track changes to standard operating conditions, or place wells with potential problems into some kind of tracking tool. The watch list is a tool that tracks a well or wells (1308), and reminds users at a pre-selected date (1306) that review is required. Once the date is reached, the data is loaded and updated in context, i.e., in the same format (1310) as the user was viewing prior to creating the Watch List, whether tabular or graphical.

The screen shot (1300) in this example is already pre-populated with the required information. The information may be inserted either manually or automatically. The following information is typically entered automatically:
Project Name
Date Created
Creator
Well/s Name
Graph/Table (i.e., the original data the user viewed before moving to the Watch List)

The Watch List name is input by the user, as is the next observation date. Defaults for creating the Watch List may also be included (1304). These may be because an alarm was triggered, or some kind of incipient trend was observed. A space for user comments is also included for the benefit of either the Watch List creator or another team member who is involved in the project. Once the save button is pushed, the Watch List is created.

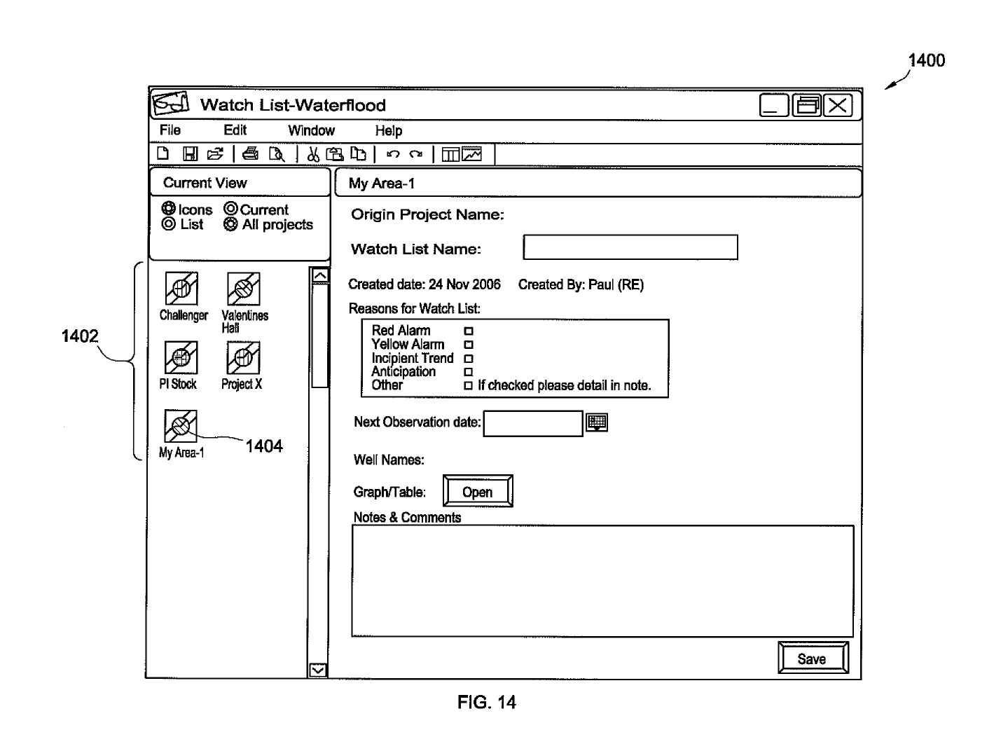

FIG. 14 shows a screen shot (1400) of what happens when a user opens a Watch List window (i.e., a new watch list is added (viewed as icon in this example)). The user has chosen to view the members (1402) of the Watch List as icons (alternatively, the user could have chosen a list view). This shows the “My-Area 1” project that has just been created. By clicking on this icon (1402), the Watch List is displayed as FIG. 13. By pressing the “Open” button next to the Graph/Table name, the Graph or Table the user was viewing when he decided to create the Watch List is opened, with all recent data included for view.

Accordingly, a user can access a Watch List at any time prior to the reminder being sent. Once a reminder is sent and the user accepts it, the Watch List, as displayed in FIG. 13, is made available for view.

In accordance with one embodiment of the invention, symbology of the icons may be used to signify special meaning. Diagonal lines signify the Watch List is within the timeframe between creation and next reminder; a cross hatch of lines signifies the Watch List is very close to (to be determined by the user) or on the day of reminder; and vertical lines signifies a reminder has been sent but the Watch List has not been accessed. Alternatively, in accordance with one embodiment of the invention, different colors may be used to signify special meanings for the Watch List (e.g., within timeframe between creating and next reminder, close to or on the day of reminder, reminder has been sent but not accessed, etc.).

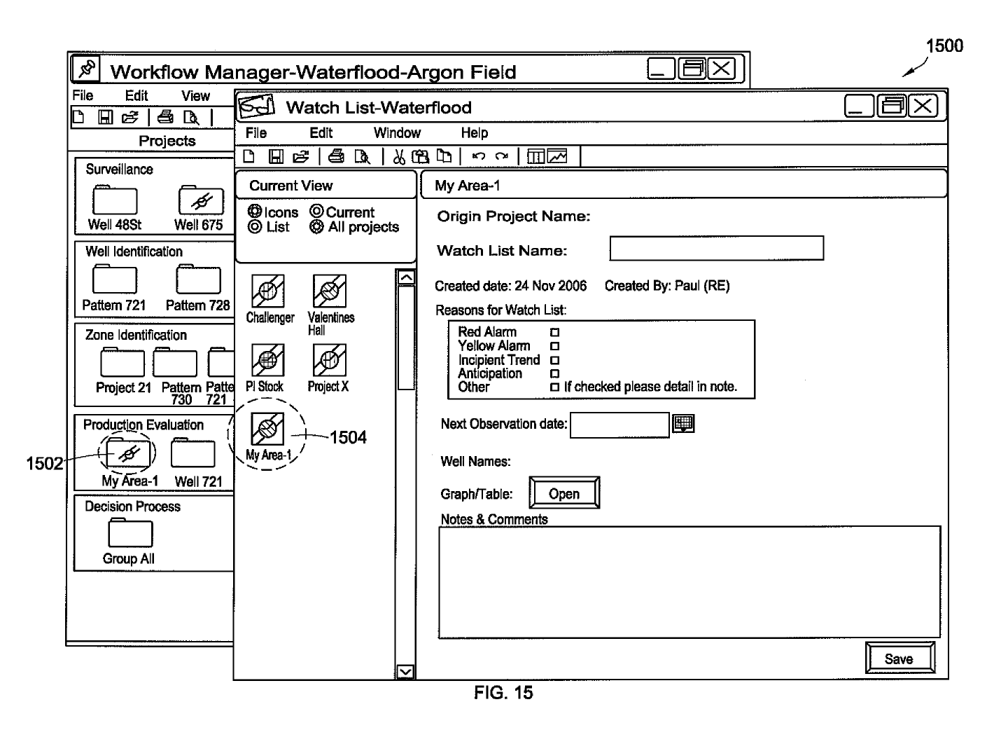

FIG. 15 shows a screen shot (1500) of what happens to the file icon in the corresponding Workflow Manager (i.e., an icon placed on project file in Workflow Manager). The workflow has reached the Production Evaluation stage at the time the user decided to add well(s) to the Watch List. As the Watch List is created, an icon (1502) appears over the file (the current example display is of a wristwatch; however, any sort of icon may be used). An icon over a project file therefore is a visual symbol that the project has information that the user needs to review again at some future date.

Flexibility in the workflow manager design allows the user to define, during installation or reconfiguration, the names and order of the tasks to display. A template of tasks, such as those shown in the figures, may be available to the user for each workflow. The user may not want to keep the tasks in the order recommended. For example, the user may want to display Zone Analysis before Well Identification. Alternatively, the user may, for example, re-name the task, change color, change font etc. Once the user decides on the workflow layout/configuration, every time the user chooses a workflow, that layout will be displayed. A default workflow layout would be displayed if no changes are made.

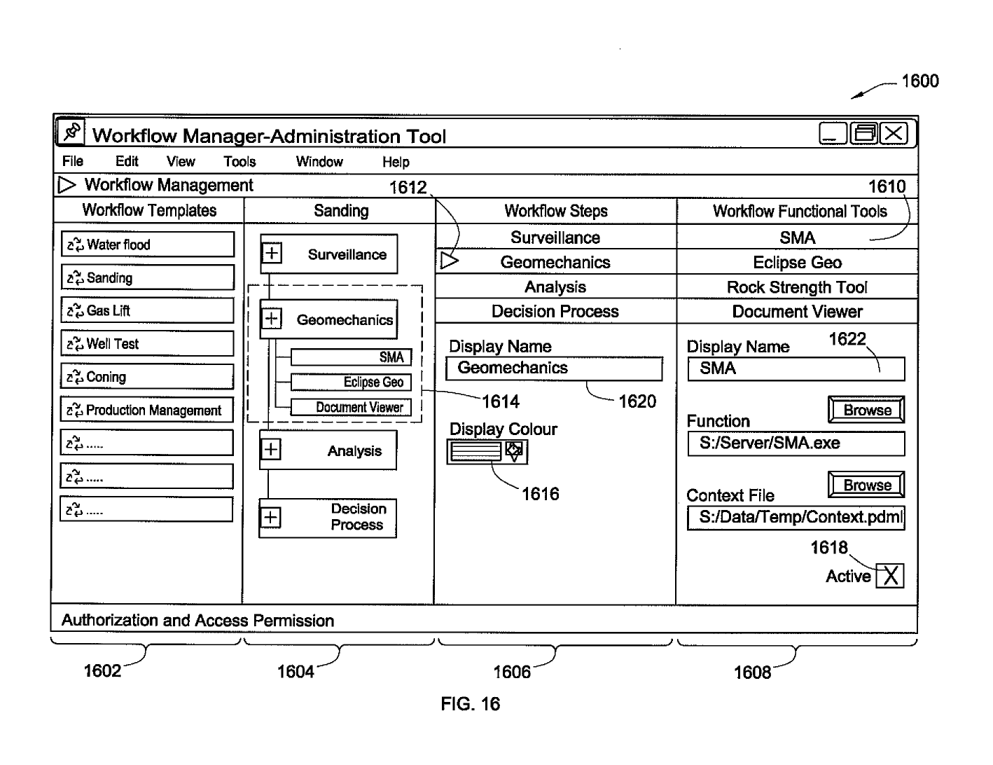

FIG. 16 shows a screen shot (1600) of an example of how the user may customize the Workflow Manager. FIG. 16 also shows the Workflow Function Tools which represent the tasks to perform. Links to graphs/table/applications (functions) are defined at this stage.

A list of workflow templates (1602) are displayed for selection. Once a workflow template is selected, the workflow states and task (1604) are displayed. Further, the user may select a workflow state to display the tasks associated with the workflow state (1614). At this point, the attributes of the selected workflow state (1606) and the attributes of the selected task (1608) may be displayed. The user may then modify attributes associated with the selected workflow task such as the display name (1620) and display color (1618). The user may also modify attributes associated with the selected task such as display name (1622), link to external function, context file, and whether the task is active (1618). External functions may include graphs, tables, or applications. The user may also specify the recommended sequence of the tasks using the user interface.

The workflow manager may provide a systematic way for problem solving and decision making, and thus allow for learning by users. By capturing results at each state a knowledge management system will be built and enable efficient problem solving for future analysis as learning takes place. Recording solution results over time may allow the development of operating and diagnostic rules to simplify future problem solving.

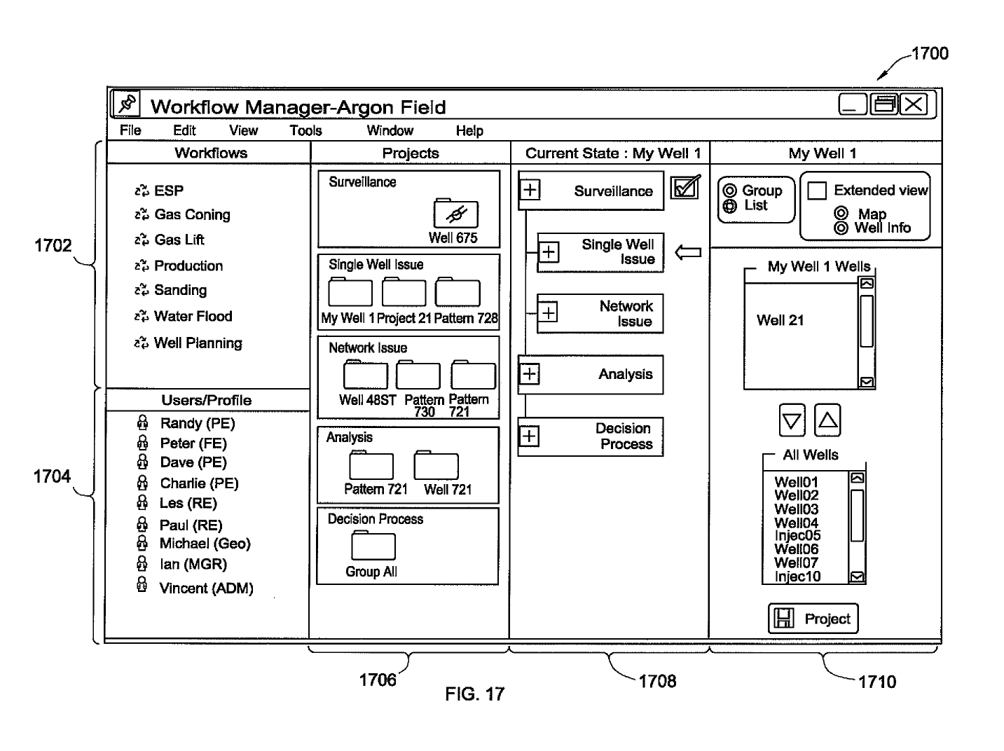

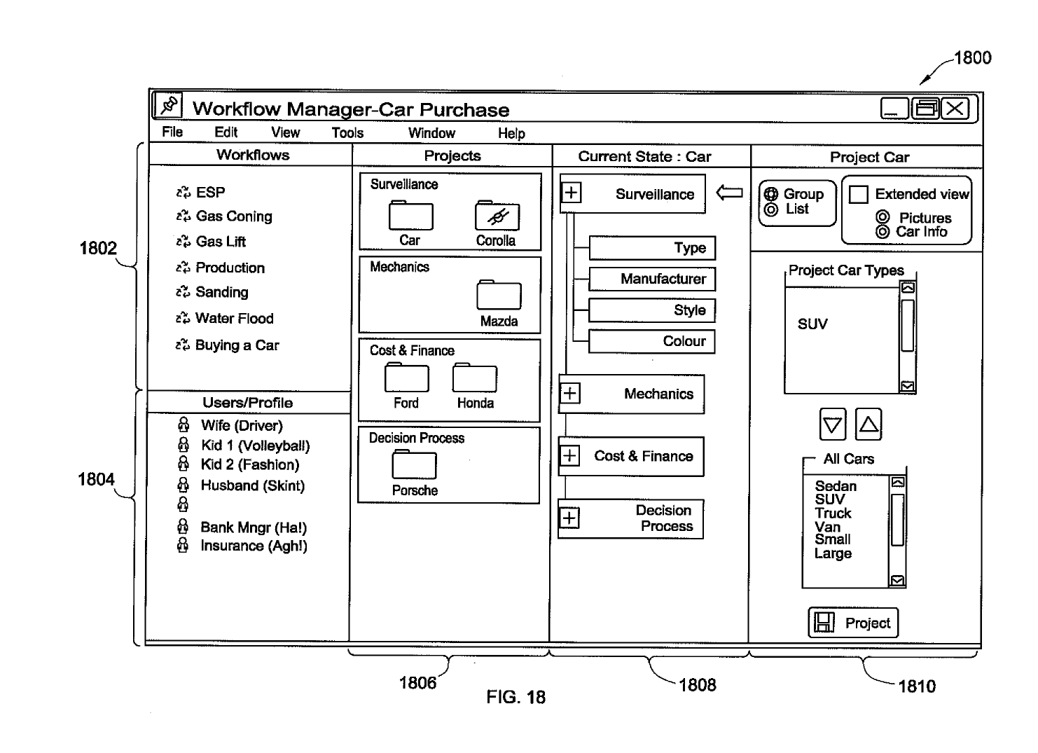

FIGS. 17 and 18 show two other screen shots. One is for a possible gas lift workflow, as shown in the screen shot (1700); the other is for buying a car, as shown in the screen shot (1800). The same interface is capable of displaying a gas lift workflow or workflow for buying an automobile.

When the gas lift workflow is selected from the list of workflows (1702), the users (1704), projects (1706), and current state of the selected project (1708) associated with the gas lift workflow are displayed. Once the user selects a task, the information associated with the selected task (1710) may also be displayed. In this case, the selected task displays information for an issue associated with a single well (1710).

Similarly, when the workflow to buy the car is selected from the list of workflows (1802), the users (1804), projects (1806), and current state of the selected project (1808) associated with the workflow are displayed. In this case, a selected task may display information related to car types (1810).

If required, this type of workflow manager could also be applied to a workflow for constructing a building, implementing a safety analysis, etc.

The current industry need is to ensure all the important steps in any particular workflow to be undertaken are visible to the user, and to ensure that learning takes place through structured processes and knowledge capture. Workflows are being defined and created, but there is no known application that will allow the users to manage the progress and capture the results through a workflow, or that allows others to see the progress without time-consuming meetings, emails, paper notes etc.

The invention may be implemented on virtually any type of computer regardless of the platform being used. For example, a computer system includes a processor, associated memory, a storage device, and numerous other elements and functionalities typical of today's computer systems. The computer system may also include input means, such as a keyboard and a mouse, and output means, such as a monitor. The computer system is connected to a local area network (LAN) or a wide area network (e.g., the Internet) via a network interface connection. Those skilled in the art will appreciate that these input and output means may take other forms.

Further, those skilled in the art will appreciate that one or more elements of the aforementioned computer system may be located at a remote location and connected to the other elements over a network. Further, the invention may be implemented on a distributed system having a plurality of nodes, where each portion of the invention (e.g., object store layer, communication layer, simulation logic layer, etc.) may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a computer readable medium such as a compact disc (CD), a diskette, a tape, a file, or any other computer readable storage device.

What is claimed is:

1. A method of managing an oilfield activity for an oilfield having at least one processing facility and at least one wellsite operatively connected thereto, each at least one wellsite having a wellbore penetrating a subterranean formation for extracting fluid from an underground reservoir therein, comprising:
identifying a problem in the oilfield activity,
wherein the oilfield activity comprises a plurality of tasks necessary to complete a first project of a plurality of projects in a workflow, and
wherein the plurality of tasks are arranged within a plurality of workflow states associated with the oilfield activity;
selectively updating a sequence for the plurality of tasks based on an analysis of the oilfield activity performed by a first user;
analyzing the first project by examining a progress of the first project within one of the plurality of workflow states to obtain a decision, wherein the first project is associated with the problem; and
resolving the problem in the oilfield activity based on the decision.

2. The method of claim 1 further comprising:
recording data and actions taken to resolve the problem, wherein the data and the actions are used to analyze the effectiveness of the resolving.

3. The method of claim 1, wherein a second project is analyzed while examining the progress of the first project.

4. The method of claim 3, wherein the progress of the first project and a progress of the second project is examined in an operations control center of the oilfield activity.

5. The method of claim 1, wherein identifying the problem comprises exceeding a pre-defined range.

6. The method of claim 1, wherein the first project is associated with a plurality of users.

7. The method of claim 1, wherein the first project is associated with a plurality of workflows.

8. The method of claim 1, wherein the first project is at least one selected from a group consisting of an asset, a pattern, and a plurality of assets.

9. The method of claim 1 further comprising:
maintaining a watch list of the plurality of projects to track the problem.

10. The method of claim 1 further comprising:
determining that the first user is an advanced user before selectively updating the sequence.

11. A method of managing an oilfield activity for an oilfield having at least one processing facility and at least one wellsite operatively connected thereto, each at least one wellsite having a wellbore penetrating a subterranean formation for extracting fluid from an underground reservoir therein, comprising:
identifying a problem in the oilfield activity,
wherein the oilfield activity comprises a plurality of tasks necessary to complete a first project of a plurality of projects in a workflow, and
wherein the plurality of tasks are arranged within a plurality of workflow states associated with the oilfield activity;
determining whether a first user is an advanced user, wherein after the determination, the first user updates the plurality of tasks;
analyzing the first project by examining a progress of the first project within one of the plurality of workflow states to obtain a decision, wherein the first project is associated with the problem; and
resolving the problem in the oilfield activity based on the decision.

12. The method of claim 11, wherein a second project is analyzed while examining the progress of the first project.

13. The method of claim 12, wherein the progress of the first project and a progress of the second project is examined in an operations control center of the oilfield activity.

14. The method of claim 11 further comprising:
recording data and actions taken to resolve the problem, wherein the data and the actions are used to analyze the effectiveness of the resolving.

15. The method of claim 11, wherein updating the plurality of tasks comprises selectively updating a sequence for the plurality of tasks based on an analysis of the oilfield activity performed by the first user.

16. A method of managing an oilfield activity for an oilfield having at least one processing facility and at least one wellsite operatively connected thereto, each at least one wellsite having a wellbore penetrating a subterranean formation for extracting fluid from an underground reservoir therein, comprising:
identifying a problem in the oilfield activity,
wherein the oilfield activity comprises a plurality of tasks necessary to complete a first project of a plurality of projects in a workflow, and
wherein the plurality of tasks are arranged within a plurality of workflow states associated with the oilfield activity;
analyzing the first project by examining a progress of the first project within one of the plurality of workflow states to obtain a decision, wherein the first project is associated with the problem;
resolving the problem in the oilfield activity based on the decision;
recording data and actions taken to resolve the problem, wherein the data and the actions are used to analyze the effectiveness of the resolving.

17. The method of claim 16, wherein a second project is analyzed while examining the progress of the first project.

18. The method of claim 17, wherein the progress of the first project and a progress of the second project is examined in an operations control center of the oilfield activity.

19. The method of claim 16 further comprising:
selectively updating a sequence for the plurality of tasks based on an analysis of the oilfield activity performed by a first user.

20. The method of claim 19 further comprising:
determining that the first user is an advanced user before selectively updating the sequence.

21. A user interface for managing an activity comprising:
a plurality of tasks necessary to complete a first project of a plurality of projects in a workflow, wherein the plurality of tasks are arranged within a plurality of workflow states associated with the activity; and
a plurality of user profiles associated with at least one of the plurality of projects,
wherein the first project is associated with the problem with the activity and analyzed by examining a progress of the first project within one of the plurality of workflow states to obtain a decision, wherein the problem in the activity is resolved based on the decision.

22. A computer system for managing an oilfield activity for an oilfield having at least one processing facility and at least one wellsite operatively connected thereto, each at least one wellsite having a wellbore penetrating a subterranean formation for extracting fluid from an underground reservoir therein, comprising:
a processor,
memory
software instruction stored in memory to execute on the processor to:
identify a problem in the oilfield activity,
wherein the oilfield activity comprises a plurality of tasks necessary to complete a first project of a plurality of projects in the workflow, and
wherein the plurality of workflow tasks are arranged within a plurality of workflow states associated with the oilfield activity;
selectively update a sequence for the plurality of tasks based on an analysis of the oilfield activity performed by a first user;
analyze the first project by examining progress of the first project within one of the plurality of workflow states to obtain a decision, wherein the first project is associated with the problem; and
resolve the problem in the oilfield activity based on the decision.

23. The computer system of claim 22, wherein the software instruction further execute on the processor to:
determine that the first user is an advanced user before selectively updating the sequence.

24. The computer system of claim 22, wherein the software instruction further execute on the processor to:
record data and actions taken to resolve the problem, wherein the data and the actions are used to analyze the effectiveness of the resolving.

25. The computer system of claim 22, wherein a second project is analyzed while examining the progress of the first project.
